(19) United States
(12) Patent Application Publication
(10) Pub. No.: US 2023/0381785 A1
(43) Pub. Date: Nov. 30, 2023

(54) SAMPLE CONTAINER HOLDING AND/OR TRANSPORTING DEVICE

(71) Applicant: Roche Diagnostics Operations, Inc., Indianapolis, IN (US)

(72) Inventors: Michael Baeurer, Bretten (DE); Andre Pristat-Gupta, Eppelheim (DE)

(73) Assignee: Roche Diagnostics Operations, Inc., Indianapolis, IN (US)

(21) Appl. No.: 18/325,328

(22) Filed: May 30, 2023

(30) Foreign Application Priority Data
May 31, 2022 (EP) 22176481.4

(51) Int. Cl. B01L 9/06

(52) U.S. Cl. CPC B01L 9/06; B01L 2200/023

(57) ABSTRACT

The disclosure relates to a sample container holding and/or transporting device having an aperture with a longitudinal axis, which aperture is configured for receiving a sample container, wherein a biasing structure is provided in the aperture, which comprises a plurality of elastically deflectable nubs, wherein the nubs are distributed spatially discrete along the longitudinal axis of the aperture. The disclosure further relates to a use of a structure having nubs as a biasing structure in a sample container holding and/or transporting device, and to a laboratory automation system comprising a sample container holding and/or transporting device.

### CROSS-REFERENCE TO RELATED APPLICATIONS

This application claims priority to European Patent Application No. 22176481.4, filed May 31, 2022, the disclosure of which is hereby incorporated by reference in its entirety.

### TECHNICAL FIELD

The disclosure relates to a sample container holding and/or transporting device, in particular for use in or with a laboratory automation system. The disclosure further relates to a use of a structure having nubs as a biasing structure in a sample container holding and/or transporting device, and to a laboratory automation system comprising a sample container holding and/or transporting device.

### BACKGROUND

A laboratory automation system comprises a number of pre-analytical, analytical and/or post-analytical stations, in which samples, for example blood, saliva, swab and other specimens taken from the human body and/or cultures, are processed. It is generally known to provide various containers, such as test tubes or vials, containing the samples. The test tubes are also referred to as sample tubes. In the context of the application, containers such as test tubes or vials for containing a sample are referred to as sample containers.

The sample container holding and/or transporting device is for example a tray, for storing and/or distributing a number of sample containers in a laboratory automation system, a rack, or a holder for holding sample containers while processing a sample in a laboratory automation system, and/or a rack or a holder for holding sample containers while collecting and/or manually preparing a sample for subsequent analysis.

Generally, different kinds of sample containers are handled in laboratory automation systems, in particular test tubes and/or vials of different diameters. An aperture of the sample container holding and/or transporting device can be provided with a biasing structure, in particular springs, which biasing structure interacts with the sample container for centering the sample container in the aperture and/or for forcing the sample container against an inelastic counterpart inside the aperture.

### SUMMARY

Although the embodiments of the present disclosure are not limited to specific advantages or functionality, it is noted that in accordance with the present disclosure a sample container holding and/or transporting device with an aperture is provided in which sample containers of different diameter can be held in a reliable and secure manner.

In accordance with one embodiment of the present disclosure, a sample container holding and/or transporting device having an aperture with a longitudinal axis, which aperture is configured for receiving a sample container, is provided, wherein a biasing structure is provided in the aperture, wherein the biasing structure comprises a plurality of elastically deflectable nubs, wherein the nubs are distributed spatially discrete along the longitudinal axis of the aperture.

According to another embodiment of the present disclosure, a method of transporting a sample container within a laboratory automation system is provided, the method comprising: configuring the sample container to hold a quantity of a human body specimen comprising at least one of blood, saliva, swab and cultures; configuring a sample container holding and/or transporting device to comprise a basic body formed therein, the basic body being accessible along a longitudinal axis thereof to the sample container through an aperture formed in an outer surface of the sample container holding and/or transporting device, wherein an inner surface of the basic body defines a plurality of elastically deflectable nubs arranged at least along the longitudinal axis; upon introduction of the sample container to the basic body through the aperture by the laboratory automation system, biasing the sample container within the basic body through cooperation between the sample container and the plurality of elastically deflectable nubs such that deflection thereof causes the sample container to be held securely within the basic body; and moving the sample container holding and/or transporting device with the sample container secured therein to at least one of a pre-analytical station, an analytical station or post-analytical station that make up the laboratory automation system.

According to yet another embodiment of the present disclosure, a laboratory automation system comprising a sample container holding and/or transporting device having an aperture with a longitudinal axis, which aperture is configured for receiving a sample container, is provided, wherein a biasing structure is provided in the aperture, wherein the biasing structure comprises a plurality of elastically deflectable nubs, wherein the nubs are distributed spatially discrete along the longitudinal axis of the aperture.

These and other features and advantages of the embodiments of the present disclosure will be more fully understood from the following detailed description take together with the accompanying claims. It is noted that the scope of the claims is defined by the recitations therein and not by the specific discussions of features and advantages set forth in the present description.

### BRIEF DESCRIPTION OF THE DRAWINGS

The following detailed description of the embodiments of the present description can be best understood when read in conjunction with the following drawings, where like structure is indicated with like reference numerals and in which:

FIG. 1 shows in a simplified sectional side view a part of a sample container holding and/or transporting device having an aperture and with a biasing structure comprising a plurality of elastically deflectable nubs according to a first embodiment in accordance with an embodiment of the present disclosure;

FIG. 2 shows in top view the aperture and with the biasing structure of FIG. 1 in accordance with an embodiment of the present disclosure;

FIG. 3 shows in a simplified sectional side view a part of a sample container holding and/or transporting device having an aperture and with a biasing structure comprising a plurality of elastically deflectable nubs according to a second embodiment in accordance with an embodiment of the present disclosure;

FIG. 4 shows in a simplified sectional side view a part of a sample container holding and/or transporting device having an aperture and with a biasing structure comprising a plurality of elastically deflectable nubs according to a third embodiment in accordance with an embodiment of the present disclosure; and

FIG. 5 shows in a top view an aperture with a biasing structure in accordance with an embodiment of the present disclosure.

Skilled artisens appreciate that elements in the figures are illustrated for simplicity and clarity and have not been drawn to scale. For example, dimensions of some of the elements in the figures may be exaggerated relative to other elements to help improve understanding of the embodiment(s) of the present disclosure.

### DETAILED DESCRIPTION

Throughout this specification and the following claims, the indefinite article “a” or “an” means “one or more”. In particular, in embodiments the sample container holding and/or transporting device has several apertures. The apertures in embodiments are arranged in one single row or in a matrix with several rows.

Upon an insertion of a sample container into the aperture equipped with a biasing structure having a plurality of nubs, the nubs are deflected allowing to securely hold sample containers of different diameters inside the aperture. A biasing force applied by the biasing structure can be adjusted to a particular application of the sample container holding and/or transporting device inter alia by selecting a number of nubs, a density in the arrangement of the nubs, a size, in particular a length and/or a diameter of the nubs, and/or a material of the nubs.

In an embodiment, the nubs are made of a natural material having a Young's modulus allowing an elastic deflection for applying a biasing force. In another embodiment, thin metal nubs are provided having a spring constant allowing an elastic deflection for applying a biasing force. In other embodiments, the nubs are made of a synthetic material. In an embodiment, the nubs are made of silicone. Silicone has the advantage that it can withstand high temperatures for sterilization, that it is highly durable, and that it retains its shape and flexibility in extreme conditions. However, the disclosure is not limited to the use of nubs made of silicone. For example, in other embodiments, the nubs are made of polymer materials such as but not limited to polyethylene materials.

In embodiments of the sample container holding and/or transporting device, the aperture has a straight cylindrical shape with a circular or polygonal, in particular triangular or rectangular, cross-section.

The biasing structure is provided in the aperture. This means, that the biasing structure at least partly protrudes into a space limited by a boundary wall of the aperture, wherein for example in case the aperture is surrounded by a boundary wall having openings, the biasing structure in part may also be arranged outside the aperture.

An arrangement and/or distribution of the nubs can be chosen by the person skilled in the art for a particular application and/or a shape of the aperture, in particular in consideration of the following advantageous embodiments.

In an embodiment, all nubs are arranged so that in an unloaded state each nub extends in a plane perpendicular to the longitudinal axis of the aperture. In one embodiment the planes, in which the nubs are arranged, are equally spaced along the longitudinal axis of the aperture. In other embodiments, the planes are unevenly spaced.

In an embodiment, the biasing structure is obtained from a flat, elastically deformable piece having a flat basic body from which the nubs protrude in a direction perpendicular to the flat basic body, wherein the elastically deformable piece is deformed for fitting into the aperature.

In an embodiment, all nubs are arranged in single row extending in parallel to the longitudinal axis of the aperture. In this embodiment, the nubs force or bias a sample container held in the aperture in one direction. In an embodiment, the aperture apart from the nubs has a smooth surface against which the sample container is forced. In other embodiments, one or several inelastic counterparts are arranged inside the aperture, wherein the nubs force the sample container against the counterpart(s).

In an alternative embodiment, the nubs are arranged in two or more rows. The two or more rows in one embodiment have the same length. In an embodiment, the nubs of two adjacent rows are arranged in a common plane perpendicular to the longitudinal axis of the aperture. In other embodiments, the nubs are arranged in a staggered pattern, wherein nubs of adjacent rows are arranged in different planes. In an embodiment, the rows are evenly distributed along a circumference of the aperture, so that the sample container held inside the aperture is centred coaxially to a centre axis of the aperture. In other embodiments, the nubs are unevenly distributed, wherein the sample container held inside the aperture is forced in a biasing direction.

In an embodiment, a distance between nubs of the one row or nubs of each row increases or decrease along the longitudinal axis to have different biasing forces applied at different heights of the sample container. In other embodiments, the nubs of the one row or the nubs of each row are evenly distributed along the longitudinal axis of the aperture.

In alternative or in addition, in an embodiment, at least two nubs arranged in different planes perpendicular to the longitudinal axis differ in length.

In one embodiment, several nubs that differ in length are alternately arranged along the longitudinal axis and/or along the circumference of the aperture. In this case, depending on its diameter, a sample container held inside the aperture interacts with all or only some of the nubs, so that different forces are applied to sample containers, which forces depend on the diameter of the sample container.

In another embodiment, a length of the nubs of the one row or of the nubs of each row decreases with an insertion depth. Hence, a degressive biasing force is applied to the sample container inserted in the aperture.

In order that the embodiments of the present disclosure may be more readily understood, reference is made to the following examples, which are intended to illustrate the disclosure, but not limit the scope thereof.

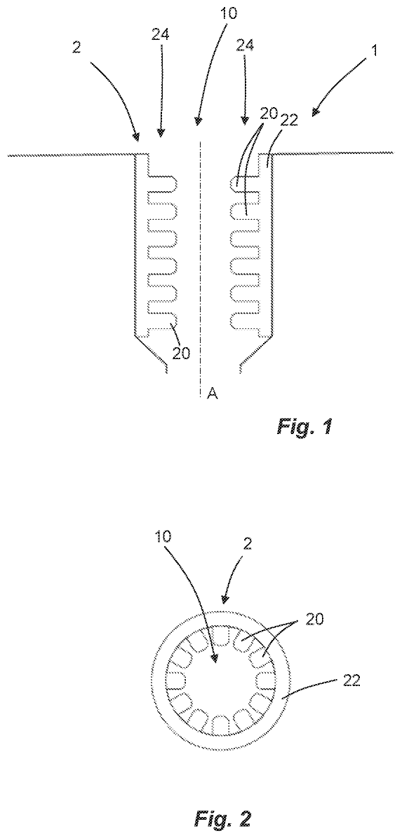

FIGS. 1 and 2 show in a simplified sectional side view and a top view a part of sample container holding and/or transporting device 1 having an aperture 10 with a biasing structure 2 comprising a plurality of elastically deflectable nubs 20 according to a first embodiment.

The aperture 10 extends along a longitudinal axis A and is configured to receive sample containers (not shown) such as test tubes or vials. In the embodiment shown, the aperture 10 has a cylindrical upper part with a circular cross-section, wherein the biasing structure 2 is arranged in the upper part of the aperture 10.

In the embodiment shown, the biasing structure 2 comprises a cylindrical basic body 22, wherein the nubs 20 protrude from the basic body 22 so that in an unloaded state as shown in FIGS. 1 and 2 each nub 20 extends in a plane perpendicular to the longitudinal axis.

The biasing structure 2 for example can be obtained from a flat, elastically deformable piece having a flat basic body 22 from which the nubs 20 protrude in a direction perpendicular to the flat basic body 22. This elastically deformable piece is deformed for fitting into the aperture 10.

In the embodiment shown in FIGS. 1 and 2 the nubs 20 are arranged in several, for example twelve rows 24, wherein only two rows 24 are visible in FIG. 1. Each row 24 extends in parallel to the longitudinal axis A of the aperture 10 and in the embodiment shown comprises several, for example six nubs 20. As shown in FIG. 1, in the embodiment shown, the rows 24 are evenly distributed along a circumference of the aperture 10, the nubs 20 of each row 24 are evenly distributed along the longitudinal axis A of the aperture 10, and all nubs 20 have the same size, i.e., the same diameter and length, and the same form. Hence, a sample container (not shown) inserted in the aperture 10 will be held to be at least essentially aligned with the longitudinal axis A by means of the biasing force applied by the nubs 20. It will be understood that the size, form, and number of nubs 20 is only by way of example and variations are possible, wherein a size, form, and number of nubs 20 as well as a material of the nubs 20 can be suitable chosen by the person skilled in the art for a particular application.

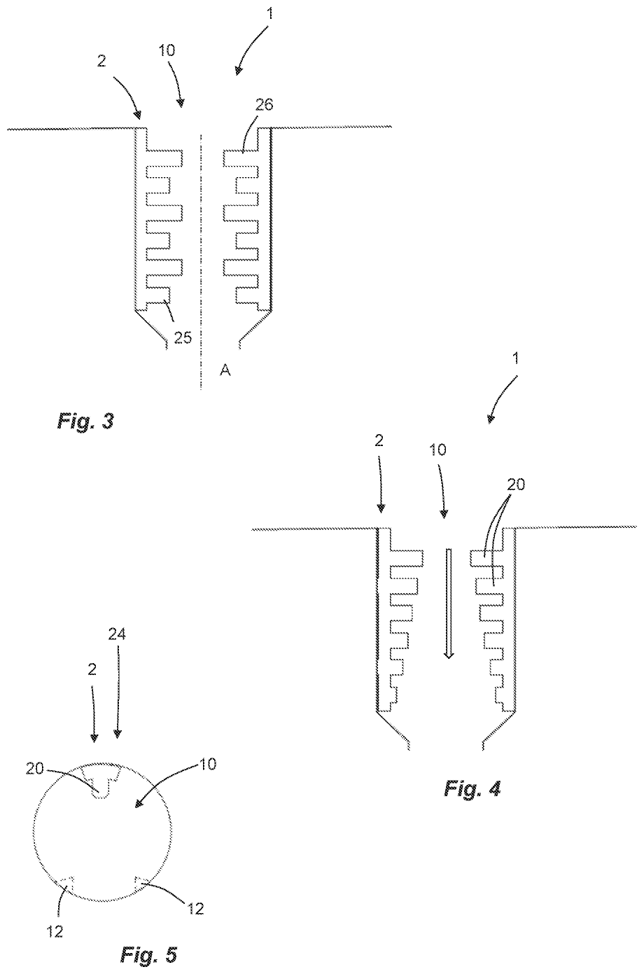

FIGS. 3, 4 and 5 show examples of alternative embodiments of biasing structures 2 having nubs 20 for use in a sample container holding and/or transporting device 1.

FIG. 3 shows in a simplified sectional side view a part of sample container holding and/or transporting device 1 having an aperture 10 in which a biasing structure 2 comprising a plurality of elastically deflectable nubs 25, 26, wherein nubs 25, 26 arranged in different planes perpendicular to the longitudinal axis A differ in length. More particular, in the embodiment shown in FIG. 3, first nubs 25 of a first length and second nubs 26 of a second length, which is longer than the first length are provided, wherein the nubs 25, 26 are alternately arranged in six planes perpendicular to the longitudinal axis A. The expression “first” and “second” are only used to distinguish between two nubs 25, 26 and not to indicate any relevance or order. In particular, in the embodiment shown, at the lowest plane first nubs 25 are arranged, whereas in other embodiments, second nubs 26 are arranged at the lowest plane. Due to the nubs 25, 26 that differ in length, different biasing forces can be applied to sample containers that differ in size.

FIG. 4 shows in a simplified sectional side view a part of sample container holding and/or transporting device 1 having an aperture 10 in which a biasing structure 2 comprising a plurality of elastically deflectable nubs 20, wherein nubs 20 arranged in different planes perpendicular to the longitudinal axis A differ in length. More particular, in the embodiment shown in FIG. 4, a length of the nubs 20 decreases with an insertion depth in the direction of an arrow shown in FIG. 4. Hence, by means of the nubs 20 decreasing in length, a degressive biasing force is applied to a sample container inserted in the aperture 10.

FIG. 5 shows in a top view an aperture 10 with a biasing structure 2 having only one row 24 of nubs 20. By means of the nubs 20, a sample container 20 is forced against an inner wall of the aperture and/or against non-deflectable counterparts 12 (shown in broken lines in FIG. 5).

It will be understood that the disclosure is not limited to the examples shown above and various variations are possible in particular by combining features of one embodiment with features of another embodiment.

What is claimed is:

1. A sample container holding and/or transporting device having an aperture with a longitudinal axis, which aperture is configured for receiving a sample container, wherein a biasing structure is provided in the aperture, wherein the biasing structure comprises a plurality of elastically deflectable nubs, wherein the nubs are distributed spatially discrete along the longitudinal axis of the aperture.

2. The sample container holding and/or transporting device according to claim 1, characterized in that in an unloaded state each nub extends in a plane perpendicular to the longitudinal axis of the aperture.

3. The sample container holding and/or transporting device according to claim 2, wherein the biasing structure is obtained from a flat, elastically deformable piece having a flat basic body from which the nubs protrude in a direction perpendicular to the flat basic body, wherein the elastically deformable piece is deformed for fitting into the aperature.

4. The sample container holding and/or transporting device according to claim 1, characterized in that the nubs are arranged in one row or in two or more rows extending in parallel to the longitudinal axis of the aperture, wherein in particular in case of two or more rows, the rows are evenly distributed along a circumference of the aperture.

5. The sample container holding and/or transporting device according to claim 2, characterized in that the nubs of the one row or the nubs of each row are evenly distributed along the longitudinal axis of the aperture.

6. The sample container holding and/or transporting device according to claim 1, characterized in that at least two nubs arranged in different planes perpendicular to the longitudinal axis of the aperture differ in length.

7. The sample container holding and/or transporting device according to claim 6, characterized in that several nubs that differ in length are alternately arranged along the longitudinal axis and/or along the circumference of the aperture.

8. The sample container holding and/or transporting device according to claim 6, characterized in that a length of the nubs decreases with an insertion depth.

9. A method of transporting a sample container within a laboratory automation system, the method comprising:
configuring the sample container to hold a quantity of a human body specimen comprising at least one of blood, saliva, swab and cultures;
configuring a sample container holding and/or transporting device to comprise a basic body formed therein, the basic body being accessible along a longitudinal axis thereof to the sample container through an aperture formed in an outer surface of the sample container holding and/or transporting device, wherein an inner surface of the basic body defines a plurality of elastically deflectable nubs arranged at least along the longitudinal axis;
upon introduction of the sample container to the basic body through the aperture by the laboratory automation system, biasing the sample container within the basic body through cooperation between the sample container and the plurality of elastically deflectable nubs such that deflection thereof causes the sample container to be held securely within the basic body; and
moving the sample container holding and/or transporting device with the sample container secured therein to at least one of a pre-analytical station, an analytical station or post-analytical station that make up the laboratory automation system.

10. The method of claim 9, wherein the plurality of elastically deflectable nubs are distributed along the longitudinal axis in at least one row.

11. The method of claim 10, wherein the at least one row defines a plurality of rows spaced circumferentially from one another.

12. The method of claim 11, wherein the plurality of rows are circumferentially evenly spaced relative to one another.

13. The method of claim 11, wherein a portion of the elastically deflectable nubs that occupy a first plane that is perpendicular to the longitudinal axis are of a different length than a portion of the elastically deflectable nubs that occupy a second plane that is perpendicular to the longitudinal axis.

14. The method of claim 13, wherein the first and second planes repeat in an alternating pattern to define additional perpendicular planes that extend along at least a majority of the longitudinal axis.

15. The method of claim 13, wherein a portion of the elastically deflectable nubs that occupy a plurality of additional planes that are perpendicular to the longitudinal axis are of a decreasing length with an increasing insertion depth along the longitudinal axis.

16. The method of claim 9, wherein the elastically deflectable nubs are arranged so that in an unloaded state each nub extend in a radially inward manner from the inner surface of the basic body.

17. The method of claim 9, wherein the elastically deflectable nubs of the at least one row are evenly distributed along the longitudinal axis of the aperture.

18. The method of claim 9, further comprising using a biasing structure for biasing the sample container within the basic body, the biasing structure formed of an elastically deformable piece having a flat basic body from which the plurality of elastically deflectable nubs protrude in a direction perpendicular to the flat basic body, wherein the elastically deformable piece is deformed for fitting into the aperature.
